(19) United States
(12) Patent Application Publication
(10) Pub. No.: US 2004/0035479 A1
(43) Pub. Date: Feb. 26, 2004

(54) Valve assembly

(76) Inventor: Pentti Airaksinen, Oulu (FI)

Correspondence Address: YOUNG & THOMPSON, 745 SOUTH 23RD STREET 2ND FLOOR, ARLINGTON, VA, 22202

(21) Appl. No.: 10/344,235

(22) PCT Filed: Aug. 14, 2001
(86) PCT No.: PCT/FI01/00713

(30) Foreign Application Priority Data
Aug. 15, 2000 (FI) 20001802

(51) Int. Cl. F16K 31/44

(52) U.S. Cl. 137/867; 251/231

(57) ABSTRACT

The invention relates to a valve assembly especially for a liquid dispensing device. It comprises a valve enclosure body (10), a valve element (13) located in the valve enclosure (10), an operating lever (14) for moving the valve element (13), and an operating lever sealing (15) in a through-hole of the valve enclosure body (10). According to the invention, the operating lever (14) is pivoted to the valve enclosure body (10) on the outside of the valve enclosure, in which case the pivot point is not in contact with the agent flowing through the valve.

### BACKGROUND OF THE INVENTION

The present invention relates to a valve assembly especially for a liquid dispensing device, which valve assembly comprises a valve enclosure body having at least a first and second outlet for an agent flowing through the valve, a valve element located in the valve enclosure and moving between two extreme positions, in which one extreme position, the valve element closes the first outlet and in the second extreme position, it closes the second outlet, an operating lever for moving the valve element and an operating lever sealing in a through-hole of the valve enclosure body, with the operating lever of the valve element connected to the valve element, led out of the valve enclosure body and pivotally engaged with the valve enclosure body at least at one point which is on a straight line running through the operating lever sealing and substantially perpendicular to the plane of travel of the operating lever, whereby the fulcrum of the lever is positioned at the location of the sealing.

A valve assembly of the type described above is disclosed in EP publication A 0 109 268. In it, a flexible flange 21 is used for mounting and sealing the operating lever of the valve element. In this construction, the operating lever does not slide in relation to its sealing, but the sealing only deforms when the operating lever is turned. Because the operating lever is mounted using the same flange 21, the flange needs to be made relatively rigid and the operating lever cannot be made very mobile. Good mobility would clearly be a negative property in the operation of the spray nozzle described in the publication. A problem with the solution is also that if such a sealing flange is used often and for a long time, the flange material becomes fatigued and the flange needs to be replaced. This replacement cannot be done without opening the valve enclosure.

In liquid dispensing devices, a valve normally connects a suction pipe from a liquid container, a plunger pump creating the flow of the liquid and a nozzle pipe distributing the liquid outside. The task of the valve is to alternately close the suction pipe and the nozzle pipe. The valve is then subjected to a continuous movement and a wear-resistant construction is required for it. The weakest point of the valve assembly is normally the outlet of the operating lever from the valve enclosure body and the sealing of this through-hole, which sealing is subjected to loads from the movement of the operating lever. When the sealing becomes brittle, the valve starts to leak, which causes disturbances in the operation of the entire dispensing device.

### BRIEF DESCRIPTION OF THE INVENTION

It is thus an object of the invention to develop a valve assembly in which the operating lever moving the valve element does not cause significant loads to the sealing, thus avoiding the danger of leakage of the valve. The object of the invention is achieved by a valve assembly which is characterized by what is stated in the independent claim. Preferred embodiments of the invention are disclosed in the dependent claims.

The invention is based on the fact that the implementation of the pivoting of the operating lever on the outer surface of the body makes it possible to make the implementation substantially maintenance-free, which is a significant advantage considering a long-term use of the device. The sealing of the operating lever also does not wear much in use, because the operating lever does not slide in use in relation to it, because the fulcrum of the operating lever is at the location of the sealing. This property, too, is achieved by a suitable mounting of the operating lever to the outer surface of the valve enclosure body.

The system of the invention provides the advantage that it is durable, because no loads are caused to the sealing part from the movement of the operating lever. The system is also characterized by a very tight construction, because the operating lever does not move significantly at the location of the sealing and the through-hole in the body can be small. In addition, the valve assembly of the invention is simple and inexpensive to implement.

### BRIEF DESCRIPTION OF THE FIGURES

The invention will now be described in more detail by means of the preferred embodiments, with reference to the attached drawing, in which

FIG. 1 shows a valve assembly of the invention, and

FIG. 2 shows a schematic diagram of an embodiment of the invention for the part of the mounting of the operating lever.

### DETAILED DESCRIPTION OF THE INVENTION

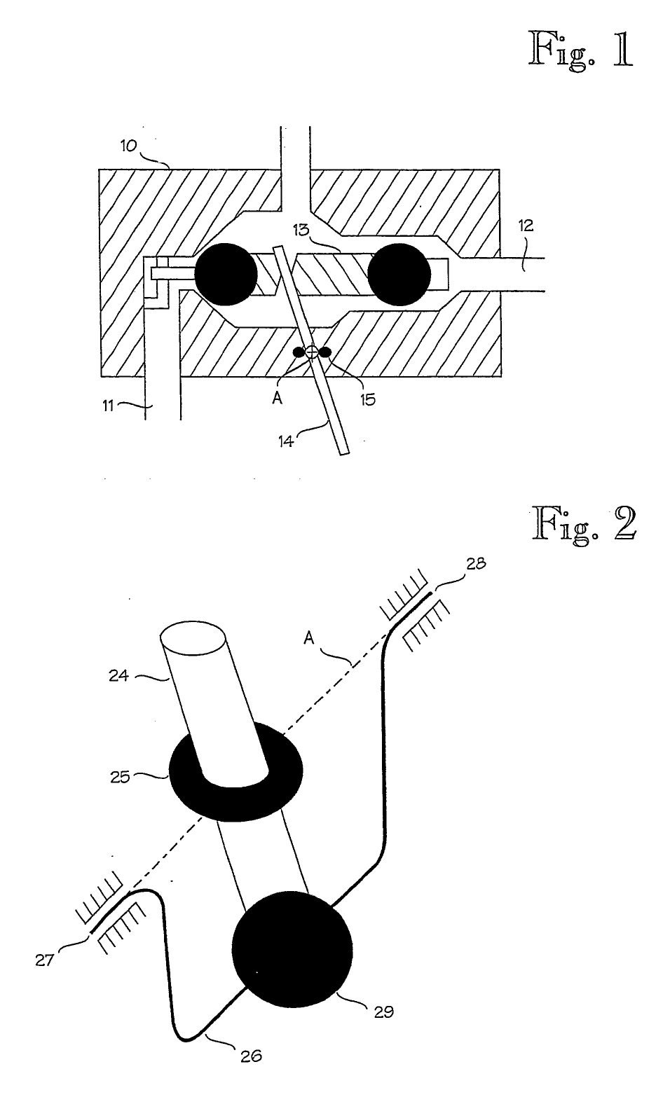

With reference to FIG. 1, the valve assembly comprises a valve enclosure body 10 having at least a first and a second outlet 11, 12 for liquid flowing through the valve. The valve construction of the figure is intended especially for use in liquid dispensing devices, in which case the first outlet 11 of FIG. 1 leads to a liquid container through a suction pipe, for instance, and the second outlet 12 is connected to liquid dispensing through a nozzle pipe, for instance. The vertical outlet in the figure connects to a plunger pump in the dispensing device.

A valve element 13 is located in the valve enclosure 10 and moves between two extreme positions. In one extreme position, the valve element 13 closes the first outlet 11 and in the second extreme position, it closes the second outlet 12. An operating lever 14 is connected to the valve element 13 for moving the valve element between the extreme positions. The operating lever 14 is lead out of the valve enclosure body 10 and the through-hole is equipped with a sealing 15. The sealing is typically an o-ring sealing.

The operating lever 14 of the valve element is connected to the valve element 13 and mounted to the valve enclosure body 10. The mounting is arranged in such a manner that the fulcrum of the lever movement guiding the valve element is at the location of the sealing 15. In other words, the operating lever is pivoted at least at one point which is on a straight line A running through the operating lever sealing 15 and substantially perpendicular to the plane of travel of the operating lever 14. In practice, the support arm of the operating lever is pivoted on the outer surface of the valve enclosure body by making suitable lugs or dents in it for the support arm of the operating lever.

FIG. 2 shows a preferred embodiment of the invention, in which the mounting of the operating lever 24 is arranged by a symmetrical two-branched support 26. The support 26 attaches to the operating lever 24 at a location 29 which is preferably outside the valve enclosure (not shown). The support 26 supports itself to the valve enclosure body at the ends 27, 28 of the branches, which are bent outward for attachment to the body. The valve enclosure body (not shown in the figure) has fastening means which receive the branch ends 27 and 28. The fastening of the branch ends 27, 28 to the valve enclosure body should allow a reciprocating movement of the operating lever and thus also the support 26. At its simplest, the required movement is made possible by a correct selection of material and shape of the branch ends and body fastening means. The fastening system operates for instance like a simple slide bearing when the circular-profile branch ends 27, 28 rotate around their longitudinal axis on the curved-surface fastening parts of the body. More complex bearing systems can also be applied to the fastening, whereby the friction between parts can be made less than before. The support of the operating [ever can alternatively be formed on the operating lever by an integrated branch or branches which settle in receiving fastenings on the outer surface of the valve body. Departing from FIG. 2, the branch ends of the support can be bent inwards, in which case they push into borings in the body from outside the valve assembly. The borings can alternatively be different structures which receive one or more branches of the support.

According to the invention, the mounting of the support to the body is characterized by a predefined location of the fastening point of the branch ends. The fastening points are located on the body on the same line A with the sealing 25 of the operating lever 24 of the valve assembly. In addition, in the described embodiment, the fastening points are located on different sides of the sealing. Because the line A formed by the fastening points of the ends 27, 28 and the sealing 25 is substantially perpendicular to the plane of travel of the lever and thus also that of the support, the lever “rocks” on the branch ends 27, 28 of the support and enables a reciprocating movement of the operating lever.

It is obvious to a person skilled in the art that the basic idea of the invention can be implemented in many different ways. The invention and its embodiments are thus not restricted to the examples described above, but can vary within the scope of the claims.

1. A valve assembly especially for a liquid dispensing device, which valve assembly comprises
a valve enclosure body (10) having at least a first and a second outlet (11, 12) for an agent flowing through the valve,
a valve element (13) located in the valve enclosure (10) and moving between two extreme positions, in which one extreme position, the valve element (13) closes the first outlet (11) and in the second extreme position, it closes the second outlet (12),
an operating lever (14, 24) for moving the valve element (13),
an operating lever sealing (15, 25) in a through-hole of the valve enclosure body (10),
with the operating lever of the valve element connected to the valve element (13), led out of the valve enclosure body (10) and pivotally engaged with the valve enclosure body (10) at least at one point (27, 28) which is on a straight line (A) running through the operating lever sealing (15, 25) and substantially perpendicular to the plane of travel of the operating lever (14, 24), whereby the fulcrum of the lever (14, 24) is positioned at the location of the sealing (15), characterized in that the operating lever (14, 24) is pivoted to the valve enclosure body (10) on the outside of the valve enclosure, in which case the pivot point is not in contact with the agent flowing through the valve.

2. A valve assembly as claimed in claim 1, characterized in that the operating lever (14, 24) is mounted by a symmetrical two-branch support (26).

3. A valve assembly as claimed in claim 1, characterized in that the branches supporting the operating lever (14, 24) are directly integrated to the operating lever (14, 24).

4. A valve assembly as claimed in any one of claims 2 to 3, characterized in that the pivot of the support (26) of the operating lever (14, 24) is made up of a circular profile of the branch end (27, 28) and a curved shape of the receiving body (10) fastening.

5. A valve assembly as claimed in any one of claims 1 to 4, characterized in that the operating lever sealing (15) is an o-ring sealing, through which the operating lever is led.
